(19) United States
(12) Patent Application Publication
(10) Pub. No.: US 2025/0333979 A1
(43) Pub. Date: Oct. 30, 2025

(54) IMPROVED LOCK CORE WITH SIDEBARS

(71) Applicant: AUSTRALIAN LOCK COMPANY PTY LTD, Unanderra, New South Wales (AU)

(72) Inventors: Changyu YOU, Unanderra, New South Wales (AU); Andrew LARKIN, Unanderra, New South Wales (AU)

(21) Appl. No.: 18/866,518

(22) PCT Filed: May 15, 2023
(86) PCT No.: PCT/AU2023/050411

§ 371 Date: Nov. 15, 2024

(30) Foreign Application Priority Data
May 16, 2022 (AU) 2022901307

(51) Int. Cl. E05B 27/00; E05B 15/16

(52) U.S. Cl. CPC E05B 27/0007; E05B 15/1614; E05B 27/0082

(57) ABSTRACT

A lock core for a pin tumbler lock, including a body, one or more side bars, a keyway, and tumbler pins located in bores in the body. A retention component, is separately formed and forms part of the core, and includes engagement features to retain the or each side bar when it is in the projecting position. Facilitates removal of the lock core without disassembly of components.

### TECHNICAL FIELD

The present invention relates to lock cores which include sidebars.

### BACKGROUND OF THE INVENTION

Lock cores in pin tumbler locks are disposed within a lock shell. When a correctly coded key is inserted in the keyway, the pins are corrected aligned by engagement with the bittings on the key, and the core can rotate within the shell.

In some pin tumbler locks, the tumbler pins in the core interact with a sidebar in order to engage or release the lock shell relative to the core. The side bar typically has extending rods, which are adapted to engage lateral recesses in the side of the tumbler pins. If the tumbler pins are not correctly aligned, the rods cannot pass within the recesses, the lock bar is held out and the lock core remains engaged with the lock shell, the side bar generally extending into a recess in the lock shell. When the tumbler pins are correctly aligned, the lateral recesses are aligned with the side bar rods, the side bar can therefore move inward towards the lock core, into an associated side bar recess in the core, and the lock core can rotate relative to the lock shell. Some locks include multiple side bars.

In some applications, the lock core is rarely or never removed from the lock shell after initial assembly. In other applications, it is desirable to be able to remove the core of the lock from the shell. An example of this is the removable core lock as used in the applicant's quick change core product, and as described in Australia Patent Application No. 1997021428, the disclosure of which is hereby incorporated by reference. If no measures are taken to retain the sidebar(s), then on removal from the lock shell, the side bars and associated springs will fall out, and need to be reassembled for insertion.

One solution, such as has been employed in the quick change core product, is to mechanically crimp several points on the edge of the side bar recess, so that the sidebar can move inwards and outwards, but not be removed from the lock core.

Crimping a brass structure such as a lock core is difficult to control to a tight tolerance. If the crimp holds the sidebar too far in, the tumbler pins cannot move freely. If the crimp doesn't retain the sidebar sufficiently, it can fall out when the core is in transport or removed from a housing.

It is an object of the present invention to provide improved sidebar retention for a pin tumbler lock.

### SUMMARY OF THE INVENTION

In a first broad form, the present invention provides an assembly for a pin tumbler lock, wherein an additional lock core component is provided, the additional component including one or more retention projections to retain the side bar in the assembled lock core.

According to one aspect, the present invention provides a lock core for a pin tumbler lock, including a body, one or more side bars, a keyway, and tumbler pins located in bores in the body, the or each side bar being adapted in a projecting position to project from the outside of the lock core, and in a released position to be received into the core when a correctly coded key is inserted into the keyway and engages the tumbler pins, wherein the body includes a retention component, separately formed and including engagement features to retain the or each side bar when it is in the projecting position.

According to another aspect, the present invention provides a A pin tumbler lock, including a lock core adapted to rotate inside a shell, the lock core, including a body, one or more side bars, a keyway, and tumbler pins located in bores in the body, the or each side bar being adapted in a projecting position to project from the outside of the lock core into s corresponding recess in the lock shell, and in a released position to be received into the core when a correctly coded key is inserted into the keyway and engages the tumbler pins, so that operatively the lock core can be rotated relative to the shell, wherein the body includes a retention component, separately formed and including engagement features to retain the or each side bar when it is in the projecting position.

In a preferred form, the retention component is formed from a hardened material, for example steel, and located adjacent to or towards the front of the keyway, so that the retention component further acts to increase the drill resistance of the lock.

The present invention also extends to a lock including a lock shell and a lock core according to the present invention, and to a retention component for a lock.

Implementations of the present invention accordingly allow for a lock core to be removed from the shell, as part of a removeable core system or otherwise, and for the side bars and associated components to be retained against dislodgement from the core.

### BRIEF DESCRIPTION OF THE DRAWINGS

An implementation of the present invention will be described with reference to the accompanying figures, in which:

FIG. 1 is an exploded view of an implementation of the present invention, showing the principle components;

FIG. 2 is a side view of the assembled lock core of FIG. 1;

FIG. 3 is an isometric view of the assembled lock core;

FIG. 4 is a view in section along lines A-A of FIG. 3;

FIG. 5 is a perspective view of the retention insert of this example; and

FIG. 6 is view illustrating the lock core and the lock shell.

### DETAILED DESCRIPTION

It will be appreciated that the examples below are intended to be illustrative of the concepts of the president invention and not limitative of the scope thereof.

The present invention will be described with reference to particular examples of lock systems. However, it will be appreciated that the invention is of general application and may be applied to a wide variety of possible lock types, for example including those having a single sidebar or a single row of pins. The invention is capable of application to different mechanisms for interaction with side bars and different tumbler pin designs and systems. The present invention further has application to locks which do not have a core change function similar to the example described.

The example below represents a modification to the locks sold commercially by the applicant as Bilock Quick Change Core, and the general functions and operation of this lock will be understood by those skilled in the art. The functionality of the lock, and the core change function, are the same as in that product. The description below should be read in the context of the Quick Change Core device, see for example http://www.australianlock.com.au/bilock-57.html.

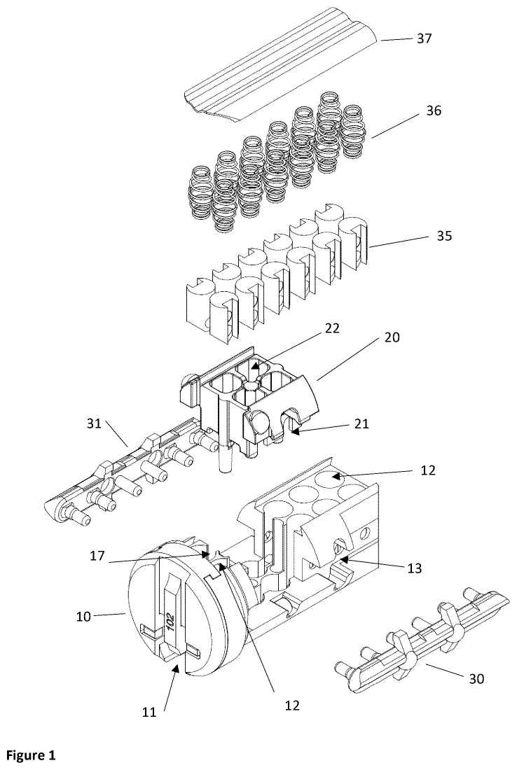

Referring to FIG. 1, this is an exploded view showing the components of this embodiment of the present invention. Lock core 10 includes a keyway 11, 8 bores 12, and a sidebar recess 13. Retention insert 20 is received into the front section of lock core 10. It includes a series of 4 bores 22, as well as a sidebar recess 21. In the assembled form, 2 bores 12 are adjacent the front face of the lock, then 4 bores 22 provided within retention insert 20, and a further 6 bores 12 are provided beyond the retention insert 20. As will be explained further below, retention insert 20 provides 4 of the bores for the tumbler pins 35.

The lock construction is completed with conventional side bars 30, 31; pins 35; springs 36, and a cover 37. Pins 35 are located in respective bores 12, 22 and biased towards the keyway 11. Cover 37 slides into a recess in the top of the core 10 and retention insert 20, so as to contain the springs 36 and pins 35.

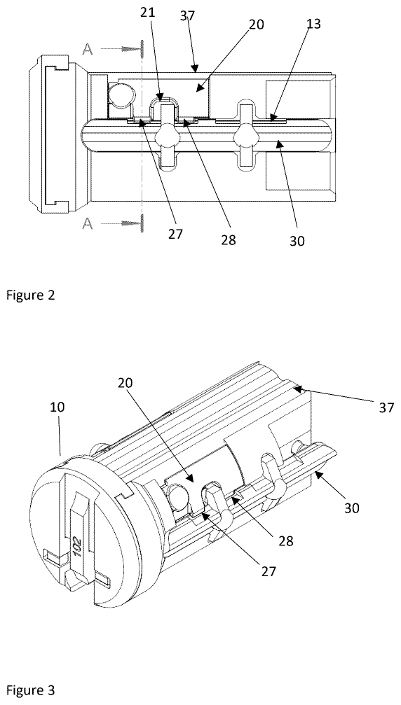

FIG. 2 is a side view, in which the side bar 30 can be seen seated within recess 13 in the lock core, and recess 21 in the retention insert 20. Thus, the general arrangement of the present implementation can be seen, in which the front section with two bores 12 in the lock core, and then four bores 22 are provided by the retention insert, and the remaining 6 bores 12 are provided in the lock core in a conventional way.

Retention component 20 also includes retention projections 27, 28 to overlay the sidebars 30, so that when the lock core assembly is removed, the sidebars do not fall out. These replace the crimped retention approach of the prior art. This can be more clearly seen in FIG. 3. It will be appreciated that the retention projections could be of a different shape, or there be more or less projections, so long as the structure is able to perform the required retention, while allowing the necessary movement of the sidebars 30, 31 in or out. It will also be understood that while only one side can be seen in this view, corresponding projection 27A, 28A are present to retain sidebar 31.

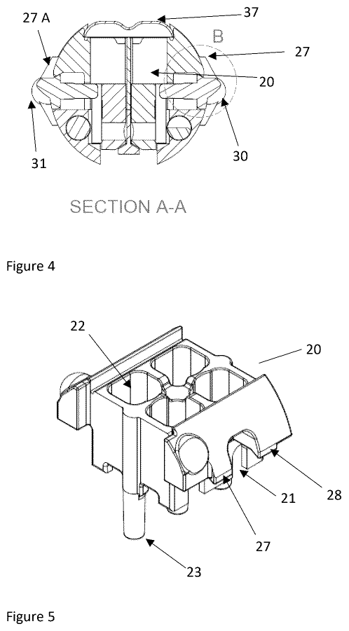

FIG. 4 is a cross-sectional view, in which the sidebars 30, 31 and the projections 27 and 27A can be seen.

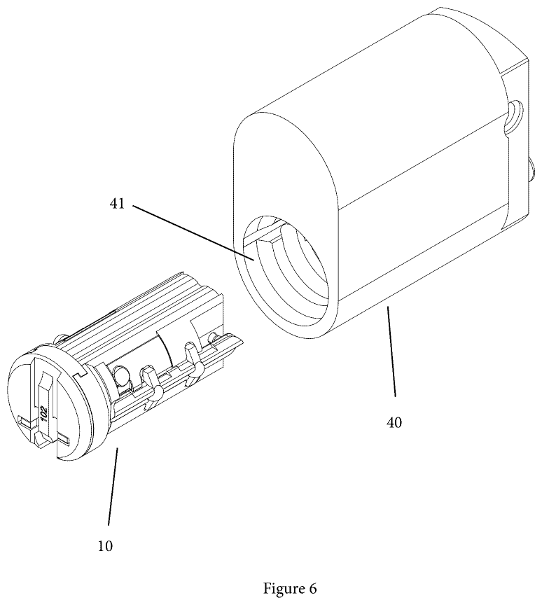

FIG. 5 shows the retention component 20 on its own, so that it can be seen that it provides 4 bores 22 for the lock core as a whole. Recess 21 allows for the sidebar to engage. Pin 23 retains and locates retention component 20 within the overall lock assembly. The front section of the retention component 20 is positioned by insertion into a recess 17 in lock core 10.

FIG. 6 shows the shell 40 and the lock core 10. It can be seen that the lock core 10 is inserted into the opening 41 in the shell, in order to complete an assembled lock.

A further advantage of the construction of this implementation is that the retention component is able to be manufactured from alternative materials to the main body of the lock, so that for example the drill resistance of the lock can be increased. The retention component may be formed, for example, from steel or an alternative hardened material. The positioning of the retention component towards the front of the lock core allows for this dual function without any requirement for additional components to improve hardening.

It will be understood that while a specific configuration has been selected for the position of the retention component within the lock core, alternative arrangements are contemplated. For example, in a shorter lock 8 pin lock, the configuration could be 2 bores in the core at the front, 4 in the retention component, and 2 bores in the core at the rear. Different splits of the bores between the retention component and the core itself are possible, as will be apparent to those skilled in the art.

It will be appreciated that the retention component could be constructed in different forms. For example, for a single sidebar system, the retention component could be on one side only, and/or include a full width section to provide drill resistance. More or less bores could be included in the retention component.

1. A lock core for a pin tumbler lock, including a body, one or more side bars, a keyway, and tumbler pins located in bores in the body, the or each side bar being adapted in a projecting position to project from the outside of the lock core, and in a released position to be received into the core when a correctly coded key is inserted into the keyway and engages the tumbler pins, wherein the body includes a retention component, separately formed and including engagement features to retain the or each side bar when it is/they are in the projecting position and wherein the retention component includes one or more of said bores and corresponding additional tumbler pins.

2. A lock core according to claim 1, wherein the retention component is formed from a hardened material relative to the body of the lock core.

3. A lock core according to claim 2, wherein the retention component is located within the body so that the bores in the retention component and the bores in the body are correctly aligned in line to permit operation of the tumbler pins by a key.

4. A pin tumbler lock, including a lock core adapted to rotate inside a shell, the lock core including a body, one or more side bars, a keyway, and tumbler pins located in bores in the body, the or each side bar being adapted in a projecting position to project from the outside of the lock core into a corresponding recess in the lock shell, and in a released position to be received into the core when a correctly coded key is inserted into the keyway and engages the tumbler pins, so that operatively the lock core can be rotated relative to the shell when the correctly coded key is inserted, wherein the body includes a retention component, separately formed and including engagement features to retain the or each side bar when it is/they are in the projecting position and wherein the retention component further includes one or more of said bores and corresponding additional tumbler pins.

5. A pin tumbler lock according to claim 4, wherein the retention component is formed from a hardened material relative to the body of the lock core.

6. A pin tumbler lock according to claim 4, wherein the retention component is located within the body so that the bores in the retention component and the bores in the body are correctly aligned in line to permit operation of the tumbler pins by the correctly coded key.

7. A retention component adapted for use in a lock core according to claim 1.

8. A retention component adapted for use in a pin tumbler lock according to claim 4.
